(19) United States
(12) Patent Application Publication
(10) Pub. No.: US 2024/0408538 A1
(43) Pub. Date: Dec. 12, 2024

(54) EJECTOR BASE FLARE GAS RECOVERY SYSTEM UTILIZING TRIETHYLENE GLYCOL

(71) Applicant: Saudi Arabian Oil Company, Dhahran (SA)

(72) Inventors: Abdullmajeed Ibrahim Al-Sanad, Dhahran (SA); Mohammed Abdulmohsin Al-Mahmood, Dhahran (SA)

(21) Appl. No.: 18/659,370

(22) Filed: May 9, 2024

Related U.S. Application Data
(60) Provisional application No. 63/507,502, filed on Jun. 12, 2023.

(51) Int. Cl. B01D 53/14; B01D 53/77; F23G 7/08

(52) U.S. Cl. CPC B01D 53/1493; B01D 53/1425; B01D 53/77; B01D 2252/2026; B01D 2258/0283; B01D 2259/4516; F23G 7/08

(57) ABSTRACT

A method for recovering a waste gas stream comprising the steps of withdrawing a contactor bottom stream from a contactor of a triethylene glycol dehydration system; mixing the contactor bottom stream with a combined motive fluid, where the combined motive fluid comprises rich TEG; mixing the combined motive fluid and the first portion of the waste gas stream in the first ejector to produce an ejector outlet stream; mixing the ejector outlet stream and the second portion of the waste gas stream in the second ejector to produce a recovered fuel stream; heating the recovered fuel stream in a glycol still condenser to produce a recovered stream; separating the recovered stream in the flash drum of the TEG dehydration system to produce a fuel gas stream and a rich TEG stream; and introducing the fuel gas stream to a reboiler fluidly connected to the glycol still condenser.

### CROSS-REFERENCE TO RELATED APPLICATIONS

This patent application claims priority from U.S. Provisional Application Ser. No. 63/507,502 filed on Jun. 12, 2023. For purposes of United States patent practice, the provisional application is incorporated by reference in its entirety.

### TECHNICAL FIELD

Disclosed are systems and methods for integrating triethylene glycol dehydration systems and flare gas recovery systems. Specifically, disclosed are systems and methods for using a triethylene glycol rich stream as the motive fluid in ejector for recovering flare gas.

### BACKGROUND

Flare gas recovery systems recover the waste gas that would be sent to the flare and thus reduce the carbon dioxide emissions from the facilities. Ejector base flare gas recovery systems are well known solutions to recover flare gas by utilizing available high-pressure sources such as sales gas or injection water. However, it can be difficult to install ejector applications in the upstream operation facilities due to the lack of typical high-pressure motive source.

### SUMMARY

Disclosed are systems and methods for integrating triethylene glycol dehydration systems and flare gas recovery systems. Specifically, disclosed are systems and methods for using a triethylene glycol rich stream as the motive fluid in ejector for recovering flare gas.

In a first aspect, a method for recovering a waste gas stream is provided. The method includes the steps of withdrawing a contactor bottom stream from a contactor of a triethylene glycol dehydration system, where the contactor bottom stream includes rich triethylene glycol (TEG), mixing the contactor bottom stream with a combined motive fluid, where the combined motive fluid includes rich TEG. The method further includes the steps of introducing the combined motive fluid to a first ejector of an ejector unit, introducing a first portion of a waste gas stream to the first ejector, where the waste gas stream includes flare gas, mixing the combined motive fluid and the first portion of the waste gas stream in the first ejector to produce an ejector outlet stream, introducing the ejector outlet stream to a second ejector, introducing a second portion of the waste gas stream to the second ejector, mixing the ejector outlet stream and the second portion of the waste gas stream in the second ejector to produce a recovered fuel stream, and r heating the recovered fuel stream in a glycol still condenser to produce a recovered stream, where the fluid in the recovered fuel stream does not mix with water vapor in the glycol still condenser. The method further includes the steps of introducing the recovered stream to a flash drum of the TEG dehydration system, separating the recovered stream in the flash drum of the TEG dehydration system to produce a fuel gas stream and a rich TEG stream, and introducing the fuel gas stream to a reboiler fluidly connected to the glycol still condenser, where the fuel gas stream comprises flare gas such that the fuel gas stream is a fuel for the reboiler.

In certain aspects, the method includes the steps of introducing the rich TEG stream to the glycol still condenser, where the glycol still condenser comprises column internals, where the rich TEG stream comprises rich TEG, separating the rich TEG stream in the glycol still condenser to produce a water vapor and rich TEG, where the rich TEG condenses through the glycol still condenser to the reboiler, heating the rich TEG in the reboiler to provide heat in the glycol still condenser, where heating the rich TEG causes the water vapor to separate from the rich TEG, collecting the triethylene glycol in an accumulator fluidly connected to the reboiler, withdrawing a lean TEG stream from the accumulator, the lean TEG stream comprises triethylene glycol, pressurizing the lean TEG stream in a pump to produce a pressurized lean stream, and introducing the pressurized lean stream to the contactor. In certain aspects, the method includes the steps of introducing the rich TEG stream to the glycol still condenser, where the glycol still condenser comprises column internals, where the rich TEG stream comprises rich TEG, separating the rich TEG stream in the glycol still condenser to produce a water vapor and rich TEG, where the rich TEG condenses through the glycol still condenser to the reboiler, heating the rich TEG in the reboiler to provide heat in the glycol still condenser, where heating the rich TEG causes the water vapor to separate from the rich TEG; collecting the triethylene glycol in an accumulator fluidly connected to the reboiler, withdrawing a lean TEG stream from the accumulator, the lean TEG stream comprises triethylene glycol, pressurizing the lean TEG stream in a pump to produce a pressurized lean stream, and mixing the pressurized lean stream into the combined motive fluid. In certain aspects, the first ejector produces vacuum due to the Venturi effect. In certain aspects, the first ejector includes a motive fluid nozzle, an inlet nozzle, and an outlet nozzle. In certain aspects, the combined motive fluid is introduced to the motive fluid nozzle of the first ejector. In certain aspects, the first portion of the waste gas stream is introduced to the inlet nozzle of the first ejector. In certain aspects, the second ejector produces vacuum due to the Venturi effect. In certain aspects, the second ejector includes a motive fluid nozzle, an inlet nozzle, and an outlet nozzle. In certain aspects, the ejector outlet stream is introduced to the motive fluid nozzle of the second ejector. In certain aspects, the second portion of the waste gas stream is introduced to the inlet nozzle of the second ejector.

In a second aspect, a method for recovering a waste gas stream is provided. The method includes the steps of introducing a combined motive fluid from a TEG dehydration system to an ejector unit, where the combined motive fluid includes rich TEG, introducing a waste gas stream to the ejector unit, where the waste gas stream includes flare gas, mixing the combined motive fluid and the waste gas stream in the ejector unit to produce a recovered fuel stream, and recycling the recovered fuel stream to the TEG dehydration system, where the recovered fuel stream includes rich TEG and flare gas.

In certain aspects, the ejector unit includes one or more ejectors. In certain aspects, the method further includes the steps of heating the recovered fuel stream in a glycol still condenser to produce a recovered stream; and separating the recovered stream in a flash drum of the TEG dehydration system to produce a fuel gas stream and a rich TEG stream. In certain aspects, the method further includes the step of introducing the fuel gas stream to a reboiler fluidly connected to the glycol still condenser of the TEG dehydration system, where the fuel gas stream includes flare gas such that the fuel gas stream is a fuel for the reboiler. In certain aspects, the combined motive fluid further includes a lean TEG stream.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a process flow diagram of an embodiment of an integrated triethylene glycol dehydration system and ejector unit.

FIG. 2 is a process flow diagram of an embodiment of an ejector unit with two ejectors.

FIG. 3 is a process flow diagram of an embodiment of an integrated triethylene glycol dehydration system and flare gas recovery system.

FIG. 4 is a process flow diagram of an embodiment of an integrated triethylene glycol dehydration system and flare gas recovery system.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The systems and methods integrate a triethylene glycol (TEG) dehydration system with an ejector system for the purpose of removing flare gas. TEG dehydration systems are widely used in natural gas recovery upstream facilities. The recovered flare gas is recycled to the TEG dehydration system to be used as fuel gas in the boilers of the TEG dehydration system. The integrated TEG dehydration system capitalizes on the wasted energy available as high pressure rich TEG as motive system to recover the flare gas. The systems and methods utilize the high pressure TEG from the bottom of multiple TEG contactor trains as the motive fluid of the ejector with multi-stage ejectors. The recovered gas is sent to the flash drum of the TEG dehydration system, where the flare gas is separated from the TEG rich stream and used as fuel gas in the existing boilers.

Advantageously, utilizing multi-stage ejectors and flow from multiple TEG trains enables flexibility in the flare gas recovery system to manage wide turnover ratio and provide stability. Advantageously, integrating the TEG dehydration system with the flare gas recovery system reduces energy consumption compared to a system using another motive fluid. Advantageously, TEG dehydration systems are widely used in natural gas upstream facilities simplifies integration with existing GOSPs. Advantageously, the methods and systems of the integrated TEG dehydration system and flare gas recovery system use waste energy that would otherwise be used to flash the TEG rich stream in an ejector application. Advantageously, the systems and methods can eliminate a knockout drum because the recycled or recovered stream from the ejectors is recycled back to the TEG flash drum.

The integrated TEG dehydration system is in the absence of amine sweetening or an amine sweetening system.

As used throughout, “flare gas” also known as associated gas refers to the natural gas produced with liquid hydrocarbons from the reservoir.

As used throughout, “rich TEG” or “rich triethylene glycol” refers to a fluid containing triethylene glycol and water. Rich TEG is also referred to as wet TEG.

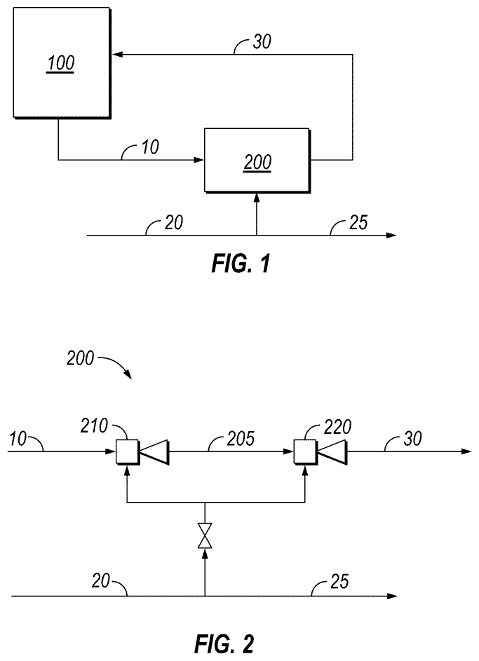

An embodiment of integrated flare gas recovery system is provided in FIG. 1. Combined motive fluid 10 from triethylene glycol (TEG) dehydration system 100 is introduced to ejector unit 200. TEG dehydration system 100 can be any type of dehydration system capable of removing water from produced natural gas. Combined motive fluid 10 can contain the flow from one or more contactors in TEG dehydration system 100 (not shown). Combined motive fluid 10 contains rich TEG.

Combined motive fluid 10 is introduced to ejector unit 200 along with waste gas stream 20. Ejector unit 200 contains one or more ejectors in series. The ejectors can be any type of ejector capable of producing vacuum by means of the Venturi effect.

Waste gas stream 20 contains flare gas. Waste gas stream 20 can be the entire flow of the flare gas header from the entire plant in which TEG dehydration system 100 is installed. In ejector unit 200 the flare gas in waste gas stream 20 is mixed with the rich TEG from combined motive fluid 10 to produce recovered fuel stream 30. Recovered fuel stream 30 is recycled to TEG dehydration system 100.

An embodiment of ejector unit 200 can be understood with reference to FIG. 2. As shown in FIG. 2, ejector unit 200 can have two ejectors, first ejector 210 and second ejector 220. Combined motive fluid 10 is introduced to first ejector 210. Ejector outlet 205 from first ejector 210 containing rich TEG and flare gas is introduced to second ejector 220. Ejector outlet stream 205 serves as the motive fluid in second ejector 220. Waste gas stream 20 can be split between first ejector 210 and second ejector 220. Recovered fuel stream 30 exits second ejector 220.

Optionally, when the flow of waste gas stream 20 is greater than ejector unit 200 can handle the excess flow can be sent to the flare stack through flare gas stream 25. Optionally, waste gas stream 20 can be fed to the flare stack.

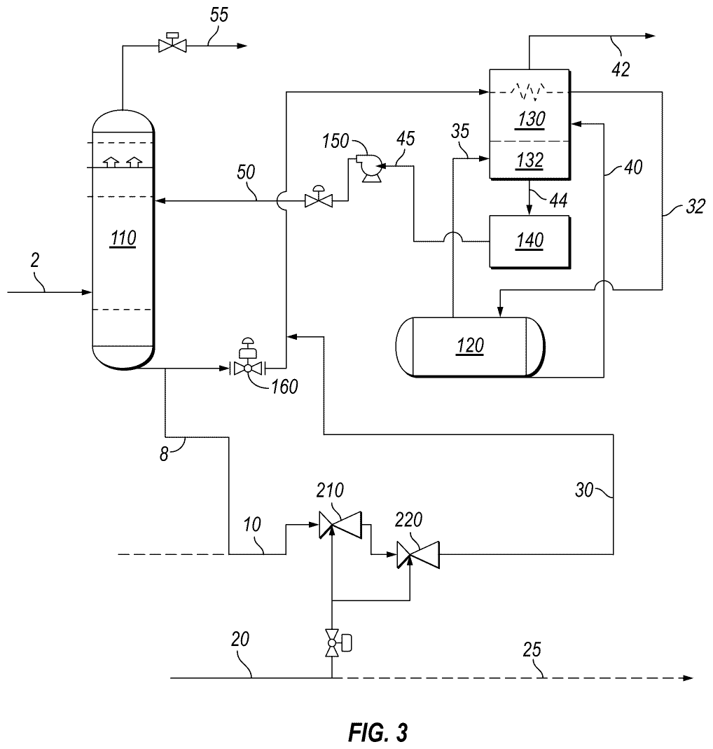

An embodiment of integrated flare gas recovery system is provided in FIG. 3. As shown, TEG dehydration system 100 includes contactor 110, flash drum 120, glycol still condenser 130, glycol reboiler 132, accumulator 140, and pump 150.

Wet gas stream 2 is introduced to contactor 110. Wet gas stream 2 contains gases and water. The gases in wet gas stream 2 include natural gas. Contactor 110 can be any type of absorber that uses triethylene glycol to separate water from the gases. In contactor 110, water in wet gas stream 2 is absorbed by triethylene glycol producing a rich TEG. Rich TEG exits the bottom of contactor 110 as contactor bottom stream 8. TEG dehydration system 100 can include more than one contactor. In embodiments where TEG dehydration system 100 includes more than one contactor, the rich TEG from the bottom of each contactor can be fed to a single contactor train header producing a combined bottom stream to produce the motive fluid, combined motive fluid 10. Contactor bottom stream 8 is mixed with combined motive fluid 10. Contactor bottom stream 8 is a high pressure stream. Contactor bottom stream 8 is at a pressure between 950 psig (6550 kPa) and 1000 psig (6991 kPa). One of skill in the art will appreciate that the number of contactors in TEG dehydration system 100 can depend on the size of the plant and volume of produced wet gas. Advantageously, utilizing the high pressure TEG system bottom stream as the motive fluid in the ejectors conserves energy by utilizing energy that would otherwise have been wasted in the process through the flash drum or the booster pumps.

Combined motive fluid 10 is introduced to ejector unit 200 as described with reference to FIGS. 1 and 2. Recovered fuel stream 30 from ejector unit 200 is cooled in glycol still condenser 130 of TEG dehydration system 100.

Recovered fuel stream 30 flows through glycol still condenser 130 where heat is added to produce heated recovered stream 35. Glycol still condenser 130 acts as a cross exchanger or a pass through exchanger for recovered fuel stream 30 such that heat is added to recovered fuel stream 30, but the fluid does not mingle with the water vapor in glycol still condenser 130. Recovered stream 32 then enters flash drum 120 of TEG dehydration system 100.

Flash drum 120 can be any type of vessel capable of separating gases and liquids due to reduction in pressure. In flash drum 120, the gases of recovered stream 32 separate from the liquids to produce fuel gas stream 35 and rich TEG stream 40. Fuel gas stream 35 contains the flare gas captured in ejector unit 200. Fuel gas stream 35 can be introduced to glycol reboiler 132 as a fuel source for the reboiler. Advantageously, introducing fuel gas stream 35 to glycol reboiler 132, the integrated flare gas recovery system reduces the amount of new fuel gas required to be introduced to the system, reducing energy consumption for the TEG dehydration system. Although FIG. 3 discloses one reboiler, one of skill in the art will appreciate that TEG dehydration system 100 can have more than one reboiler. In at least one embodiment, each contactor will have its own reboiler.

The liquid exits flash drum as rich TEG stream 40. The liquid in flash drum 120 includes rich TEG containing water and triethylene glycol. Rich TEG stream 40 is introduced to glycol still condenser 130.

Glycol still condenser 130 separates the water from the triethylene glycol in rich TEG stream 40 to produce lean TEG stream 45 and water vapor 42. Glycol still condenser 130 can be an internal still column condenser. Glycol still condenser 130 can include column internals that can cause glycol to condense and flow toward reboiler 134. Column internals can include packed internals, trays, and combinations of the same. Column internals can be arranged both above and below the inlet of rich TEG stream 40.

Reboiler 134 provides the heat to drive the separation of water and triethylene glycol in glycol still condenser 130. Reboiler 134 operates at a temperature greater than the boiling point of water (100° C.) and less than the boiling point of triethylene glycol (285° C.). In at least one embodiment, reboiler 134 operates at a temperature of 204° C.

Rich TEG stream 40 enters glycol still condenser 130 and condenses through the column internals toward reboiler 134. As the fluid condenses through the column internals the temperature will increase and the water in rich TEG stream 40 will turn to steam or water vapor and flow upward. Any water that reaches the reboiler will be heated to a point above the boiling point of water producing steam which will flow upward through glycol still condenser carrying heat and removing water from the rich TEG leaving triethylene glycol in the reboiler. The water exits as water vapor 42. Water vapor 42 exiting glycol still condenser 130 can be recovered and further processed or sent for disposal. The triethylene glycol can flow into accumulator 140. Reboiler 140 can include a weir and stripping gas to aid in the separation of the triethylene glycol from the rich TEG in the reboiler.

Reboiler outlet 44 flows from reboiler 132 to accumulator 140. Reboiler outlet 44 contains triethylene glycol. Accumulator 140 collects the triethylene glycol separated from the rich TEG through reboiler 132 and glycol still condenser 130. The use of accumulator 140 enables TEG dehydration system 100 to handle fluctuations in the flow rate or surges in the system. When the levels in accumulator 140 allow, lean TEG stream 45 can be withdrawn. Lean TEG stream 45 contains triethylene glycol.

Lean TEG stream 45 can be pressurized in pump 150 to produce pressurized lean stream 50. Pressurized lean stream 50 can be introduced to the top of contactor 110.

After the water is absorbed by the triethylene glycol in contactor 110, the gases present in wet gas stream 2 exit in dry gas stream 55.

TEG dehydration system 100 can include control valves to control the system. Contactor bottom stream 8 can be removed from TEG dehydration system 100 upstream of bottom level control valve (LCV) 160 that can operate to control the level in flash drum 120. Bottom LCV 160 can also reduce disruptions by bypassing the ejectors but still allowing the TEG dehydration system to run normally.

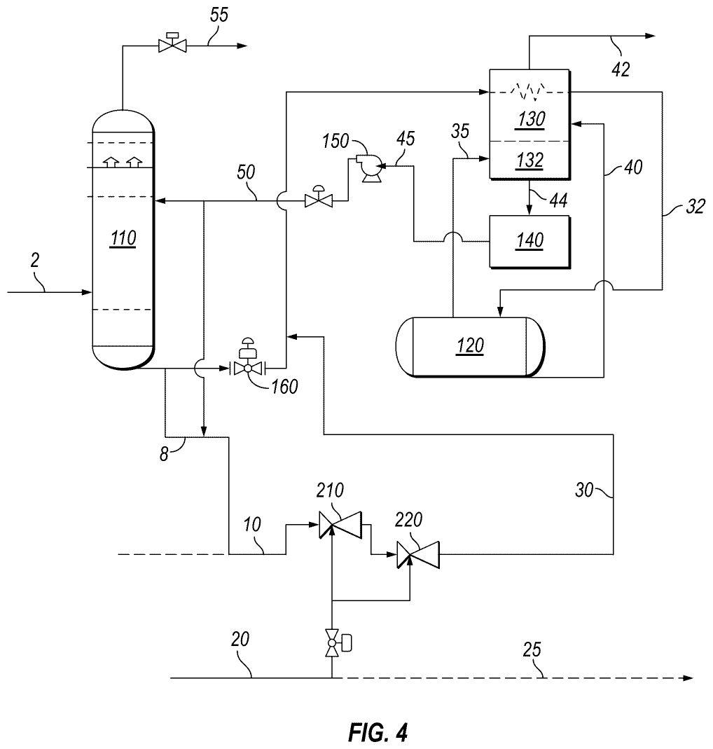

Referring to FIG. 4, an alternate embodiment of integrated flare gas recovery system is provided. Pressurized lean stream 50 can be mixed with contactor bottom stream 8 to be introduced as part of combined motive fluid 10. In at least one embodiment, pressurized lean stream 50 can be used as the entire volume of combined motive fluid 10. In this embodiment, rich TEG from the bottom of contactor 110 is introduced directly to flash drum 120 through glycol still condenser 130. Advantageously, using pressurized lean stream 50 as part or all of the flow for combined motive fluid 10 enables the integrated flare gas recovery system to handle fluctuations in flow rate through TEG dehydration system 100. Waste gas 20 can continue to be recovered through ejector unit 200 even when the flow through contactor 110 is not consistent.

Advantageously, the integrated flare gas system uses energy from the TEG process in the form of the motive fluid to recycle waste gas from other points in the plant, such as a gas oil separation plant, and recycle it back to the TEG process. By capturing the waste gas, the integrated flare gas system both reduces the amount of waste that would otherwise be routed to the flare systems and reduces the amount of external fuel gas that needs to be introduced to the TEG process. Advantageously, by utilizing the TEG contactor bottom stream as the motive fluid in the ejectors the integrated flare gas system can eliminate additional equipment such as letdown stations and knockout drums as the process lines will return to the flash drum.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

That which is claimed is:

1. A method for recovering a waste gas stream comprising the steps of:
withdrawing a contactor bottom stream from a contactor of a triethylene glycol dehydration system, where the contactor bottom stream comprises rich (triethylene glycol) TEG;
mixing the contactor bottom stream with a combined motive fluid, where the combined motive fluid comprises rich TEG;
introducing the combined motive fluid to a first ejector of an ejector unit;
introducing a first portion of a waste gas stream to the first ejector, where the waste gas stream comprises flare gas;
mixing the combined motive fluid and the first portion of the waste gas stream in the first ejector to produce an ejector outlet stream;
introducing the ejector outlet stream to a second ejector;
introducing a second portion of the waste gas stream to the second ejector;
mixing the ejector outlet stream and the second portion of the waste gas stream in the second ejector to produce a recovered fuel stream;
heating the recovered fuel stream in a glycol still condenser to produce a recovered stream, where the fluid in the recovered fuel stream does not mix with water vapor in the glycol still condenser;
introducing the recovered stream to a flash drum of the TEG dehydration system;
separating the recovered stream in the flash drum of the TEG dehydration system to produce a fuel gas stream and a rich TEG stream; and
introducing the fuel gas stream to a reboiler fluidly connected to the glycol still condenser, where the fuel gas stream comprises flare gas such that the fuel gas stream is a fuel for the reboiler.

2. The method of claim 1, further comprising the steps of:
introducing the rich TEG stream to the glycol still condenser, where the glycol still condenser comprises column internals, where the rich TEG stream comprises rich TEG;
separating the rich TEG stream in the glycol still condenser to produce a water vapor and rich TEG, where the rich TEG condenses through the glycol still condenser to the reboiler;
heating the rich TEG in the reboiler to provide heat in the glycol still condenser, where heating the rich TEG causes the water vapor to separate from the rich TEG;
collecting the triethylene glycol in an accumulator fluidly connected to the reboiler;
withdrawing a lean TEG stream from the accumulator, the lean TEG stream comprises triethylene glycol;
pressurizing the lean TEG stream in a pump to produce a pressurized lean stream; and
introducing the pressurized lean stream to the contactor.

3. The method of claim 1, further comprising the steps of:
introducing the rich TEG stream to the glycol still condenser, where the glycol still condenser comprises column internals, where the rich TEG stream comprises rich TEG;
separating the rich TEG stream in the glycol still condenser to produce a water vapor and rich TEG, where the rich TEG condenses through the glycol still condenser to the reboiler;
heating the rich TEG in the reboiler to provide heat in the glycol still condenser, where heating the rich TEG causes the water vapor to separate from the rich TEG;
collecting the triethylene glycol in an accumulator fluidly connected to the reboiler;
withdrawing a lean TEG stream from the accumulator, the lean TEG stream comprises triethylene glycol;
pressurizing the lean TEG stream in a pump to produce a pressurized lean stream; and
mixing the pressurized lean stream into the combined motive fluid.

4. The method of claim 1, where the first ejector produces vacuum due to the Venturi effect.

5. The method of claim 1, where the first ejector comprises a motive fluid nozzle, an inlet nozzle, and an outlet nozzle.

6. The method of claim 4, where the combined motive fluid is introduced to the motive fluid nozzle of the first ejector.

7. The method of claim 4, where the first portion of the waste gas stream is introduced to the inlet nozzle of the first ejector.

8. The method of claim 1, where the second ejector produces vacuum due to the Venturi effect.

9. The method of claim 1, where the second ejector comprises a motive fluid nozzle, an inlet nozzle, and an outlet nozzle.

10. The method of claim 8, where the ejector outlet stream is introduced to the motive fluid nozzle of the second ejector.

11. The method of claim 8, where the second portion of the waste gas stream is introduced to the inlet nozzle of the second ejector.

12. A method for recovering a waste gas stream, the method comprising the steps of:
introducing a combined motive fluid from a TEG dehydration system to an ejector unit, where the combined motive fluid comprises rich TEG;
introducing a waste gas stream to the ejector unit, where the waste gas stream comprises flare gas;
mixing the combined motive fluid and the waste gas stream in the ejector unit to produce a recovered fuel stream; and
recycling the recovered fuel stream to the TEG dehydration system, where the recovered fuel stream comprises rich TEG and flare gas.

13. The method of claim 12, where the ejector unit comprises one or more ejectors.

14. The method of claim 12, further comprising the steps of:
heating the recovered fuel stream in a glycol still condenser to produce a recovered stream; and
separating the recovered stream in a flash drum of the TEG dehydration system to produce a fuel gas stream and a rich TEG stream.

15. The method of claim 14, further comprising the step of introducing the fuel gas stream to a reboiler fluidly connected to the glycol still condenser of the TEG dehydration system, where the fuel gas stream comprises flare gas such that the fuel gas stream is a fuel for the reboiler.

16. The method of claim 12, where the combined motive fluid further comprises a lean TEG stream.
